(19) United States
(12) Patent Application Publication
(10) Pub. No.: US 2025/0125434 A1
(43) Pub. Date: Apr. 17, 2025

(54) HIGH-FREQUENCY ALTERNATING CURRENT BATTERY HEATING USING VOLTAGE COMMANDS

(71) Applicant: GM GLOBAL TECHNOLOGY OPERATIONS LLC, Detroit, MI (US)

(72) Inventors: Renato Amorim Torres, Pontiac, MI (US); Suresh Gopalakrishnan, Troy, MI (US); Lei Hao, Troy, MI (US); Chandra S. Namuduri, Troy, MI (US); Vinod Chowdary Peddi, Shelby Charter Township, MI (US)

(73) Assignee: GM GLOBAL TECHNOLOGY OPERATIONS LLC, Detroit, MI (US)

(21) Appl. No.: 18/484,552

(22) Filed: Oct. 11, 2023

(51) Int. Cl. H01M 10/615; B60L 58/27

(52) U.S. Cl. CPC H01M 10/615; B60L 58/27; B60L 2240/545; H01M 2220/20

(57) ABSTRACT

A method for heating a battery pack of an electrified powertrain system having an electric motor includes determining a temperature of the battery pack. Responsive to the battery temperature being less than a predetermined threshold temperature, the method includes executing a self-heating mode of the battery pack. This includes injecting a high-frequency direct-axis alternating current voltage waveform that minimizes output torque and prevents rotation of a rotor of the electric motor. An AC current waveform is applied to the battery pack as a result of the voltage injection. A controller includes a temperature sensor configured for determining a temperature of the battery pack and a processor configured to perform the method. A motor vehicle includes the controller, an electrified powertrain system having the battery pack and an electric motor, and road wheels connected to and powered by electric motor.

### INTRODUCTION

The present disclosure relates to electrical systems having an electrochemical battery pack connected to an alternating current (AC)-powered electric motor via an inverter, e.g., a traction power inverter module of a motor vehicle, as well as to computer-based control methodologies for internally heating constituent battery cells of the battery pack using a high-frequency AC current waveform.

Advanced hybrid-electric and full-electric motor vehicles include one or more electric traction motors. Each traction motor is energized by a controlled discharge of traction a lithium-ion battery pack, or one having an application-suitable battery chemistry. Under cold ambient conditions, constituent battery cells of the battery pack are typically warmed to a threshold temperature prior to offboard charging. However, the motor vehicle could lack a resident fluidic thermal management system (TMS), or the heating response of an available onboard TMS could be suboptimal for a given charging scenario or prevailing weather conditions.

### SUMMARY

Disclosed herein are electric circuit topologies and related control methodologies for heating an electrochemical battery pack of an electrified powertrain system, e.g., of a hybrid electric vehicle or a battery electric vehicle. The present solutions enable selective high-frequency alternating current (AC) current-based internal heating (“self-heating”) of the battery pack to occur. In particular, self-heating is initiated by transmitting direct-axis (d-axis) and quadrature-axis (q-axis) voltage commands to a power inverter module (PIM) of the electrified powertrain system, with the PIM in turn being connected to an electric traction motor. Zero-sequence voltage commands may also be used in certain implementations, for example when the traction motor has a neutral connection point.

When manipulating the d-axis voltage command in accordance with the disclosure, the q-axis voltage command is set to zero. A high-frequency AC current waveform is thus generated as a result of the d-axis voltage commands, and then applied across electrode terminals of the battery pack for heating thereof. That is, the present approach includes creating unbalanced AC currents in the traction motor that ultimately result in the AC current in the battery pack. As part of the present control strategy, an angular position of a rotor of the aforementioned traction motor may be controlled in a closed-loop to minimize residual rotor torque that could otherwise result from slight variations from zero in the q-axis voltage command, and/or a reluctance torque or a magnetic torque could be created via a total voltage command to maintain a desired rotor position.

In particular, a method for heating a battery pack of an electrified powertrain system having at least one electric motor includes determining a temperature of the battery pack via a temperature sensor, with the temperature treated herein as a measured battery temperature. Responsive to a set of entry conditions, the method includes performing a self-heating mode of the battery pack via an electronic controller, including injecting a high-frequency AC voltage waveform onto a d-axis of the electric motor, i.e., across terminals of the electric motor. This occurs via a d-axis voltage command in conjunction with a quadrature-axis (q-axis) voltage command of zero to heat the battery pack. The entry conditions may include the measured battery temperature being less than a lower temperature limit.

Embodiments of the method may include applying an AC current waveform across electrode terminals of the battery pack during the self-heating mode in response to injecting the high-frequency AC voltage waveform to the d-axis of the electric motor.

The method could include detecting a threshold rotation of a rotor of the electric motor and adjusting a total voltage command, via the electronic controller, in response to the threshold rotation of the rotor.

Injecting the high-frequency AC voltage waveform onto the d-axis of the electric motor may include generating a pulsating d-axis voltage command via a closed-loop position control routine of the rotor. Generating the pulsating d-axis voltage command includes using a linear combination of a varying d-axis voltage command and/or using a constant d-axis voltage command. Generating the pulsating d-axis voltage command may also include using a varying zero-sequence voltage command and/or using a constant zero-sequence voltage command.

The electronic controller in one or more implementations includes a current regulator. The method in some an embodiment may include selectively increasing an injection frequency of the d-axis voltage injection and a bandwidth of the current regulator via the electronic controller. The method may also include changing from voltage control of the electric motor to current control of the electric motor when an injection frequency of the d-axis voltage injection is within the bandwidth of the current regulator.

The method disclosed herein may also include determining a control angle of the electric motor during the self-heating mode, and then using the control angle to maintain an angular position of a rotor of the electric machine during the self-heating mode.

Embodiments may include calculating a reluctance torque when the control angle exceeds a calibrated value, thereafter, repositioning the rotor using the reluctance torque. Alternatively, the method may include calculating a magnetic torque when the control angle exceeds a calibrated value, and then repositioning the rotor using the magnetic torque.

Also disclosed herein is an electronic controller for use with an electrified powertrain system having a battery pack and an electric motor. The electronic controller in a possible construction includes a temperature sensor and a processor. The temperature sensor is configured for measuring a temperature of the battery pack. The processor, which is in communication with the temperature sensor, receives the temperature of the battery pack from the temperature sensor as a measured battery temperature. Responsive to a set of entry conditions, the conditions including the measured battery temperature being less than a lower temperature limit, the electronic controller is configured to perform a self-heating mode of the battery pack, including injecting a high-frequency AC voltage waveform onto the d-axis of the electric motor, via a d-axis voltage command in conjunction with a q-axis voltage command of zero, to thereby heat the battery pack.

A motor vehicle is also disclosed herein having road wheels and an electrified powertrain system having a battery pack and an electric motor, the latter having a rotor that is connected to one or more of the road wheels. The motor vehicle also includes an electronic controller having a temperature sensor configured for determining a temperature of the battery pack, and a processor in communication with the temperature sensor. The processor in this particular embodiment is configured to receive the temperature of the battery pack as a measured battery temperature. Responsive to a set of entry conditions including the measured battery temperature being less than a lower temperature limit, perform a self-heating mode of the battery pack by commanding injection of a high-frequency AC voltage waveform onto the d-axis of the electric motor. This occurs via a d-axis voltage command in conjunction with a q-axis voltage command of zero, and is used to heat the battery pack by causing an AC current waveform to be applied across electrode terminals of the battery pack.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 illustrates a representative motor vehicle having an electrified powertrain system in which a battery pack is heated via the control methodology set forth in detail herein.

FIG. 2A is a circuit diagram depicting an exemplary electronic controller usable for performing aspects of the self-heating methodology of the present disclosure, usable for rotor positioning/locking using reluctance torque.

FIG. 2B is a circuit diagram depicting an alternative embodiment of the electronic controller of FIG. 2A, usable for rotor positioning/locking using magnetic torque.

FIG. 3 illustrates a representative circuit topology for injecting a pulsating current waveform into the battery pack via a direct-axis (d-axis) voltage command in accordance with an aspect of the disclosure.

FIGS. 4A, 4B, and 4C are vector diagrams that collectively illustrate an application of a pulsating current output.

FIGS. 5A, 5B, and 5C are control variables corresponding to FIGS. 4A, 4B, and 4C, respectively.

FIG. 6 is a simplified illustration of a rotor of an electric motor within the electrified powertrain system of FIG. 1.

FIGS. 7A-7D are representative time plots of parameters in accordance with the present disclosure.

FIG. 8 is a flow chart describing an exemplary method for self-heating the battery pack of FIG. 1.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

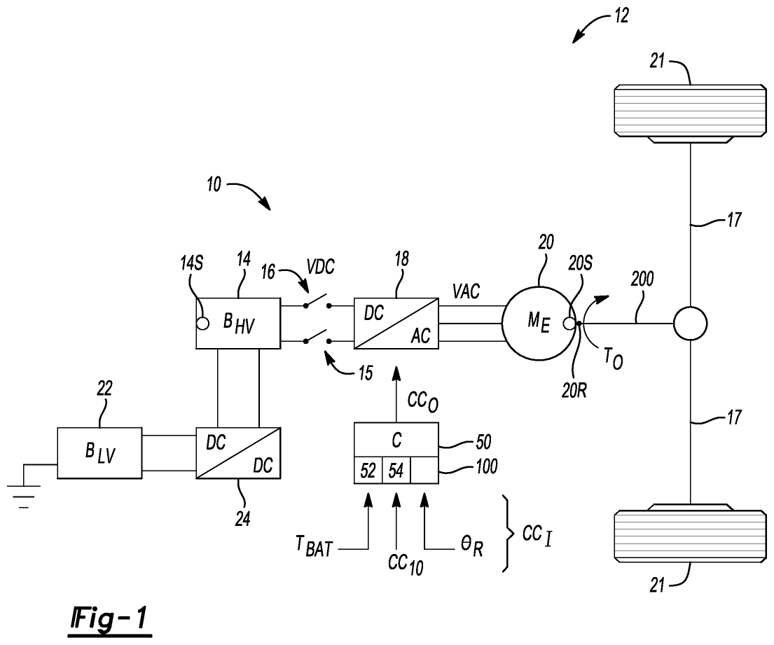

Referring to the drawings, wherein like reference numerals correspond to like or similar components throughout the several Figures, an electrified powertrain system 10 is illustrated in FIG. 1. The electrified powertrain system 10, which in one or more embodiments may be used aboard a motor vehicle 12, includes a high-voltage traction battery pack (BHV) 14. The traction battery pack 14 is connected to a direct current (DC) voltage bus 15 via a main battery contactor set 16. A power inverter module (“DC/AC”) 18, hereinafter referred to as an inverter 18 for simplicity, is electrically connected to the traction battery pack 14 via the DC voltage bus 15, with the illustrated open state of the contactor set 16 corresponding to a disconnected state of the traction battery pack 14.

In the illustrated embodiment of FIG. 1, an electric traction motor (ME) 20 is connected to the alternating current (AC)-side of the inverter 18. While shown as a single electric traction motor 20 and a single inverter 18 for illustrative simplicity, the present disclosure may be extended to multi-inverter/multi-motor powertrains, as will be appreciated by those skilled in the art. Thus, a DC voltage (VDC) present on the DC voltage bus 15 is converted to an AC voltage (VAC) suitable for energizing individual phase windings of the electric traction motor 20. When energized, a rotor 20R of the electric traction motor 20 produces an output torque (To), with the output torque (To) being directed via an output member 200 that is coupled to the rotor 20R. Rotation of the output member 200 is ultimately imparted to one or more drive axles 17, and ultimately to one or more driven road wheels 21 connected to the drive axles 17, with two driven road wheels 21 illustrated in FIG. 1 for simplicity.

HIGH-FREQUENCY AC SELF-HEATING MODE: AC-based internal heating of the traction battery pack 14 (“self-heating”) as contemplated herein requires the selective application to the traction battery pack 14 of a high-frequency alternating current. The term “high frequency” as used herein may include about 200 hertz (Hz) to 1 kHz or more in a possible/non-limiting implementation. However, a maximum bandwidth of a typical current controller of use in the realm of AC motor control is often less than 200 Hz, and thus insufficient for optimal AC-based self-heating of the traction battery pack 14. That is, the larger the difference between signal frequency and an available controller bandwidth, the larger the resulting error between commanded and actual d-axis values.

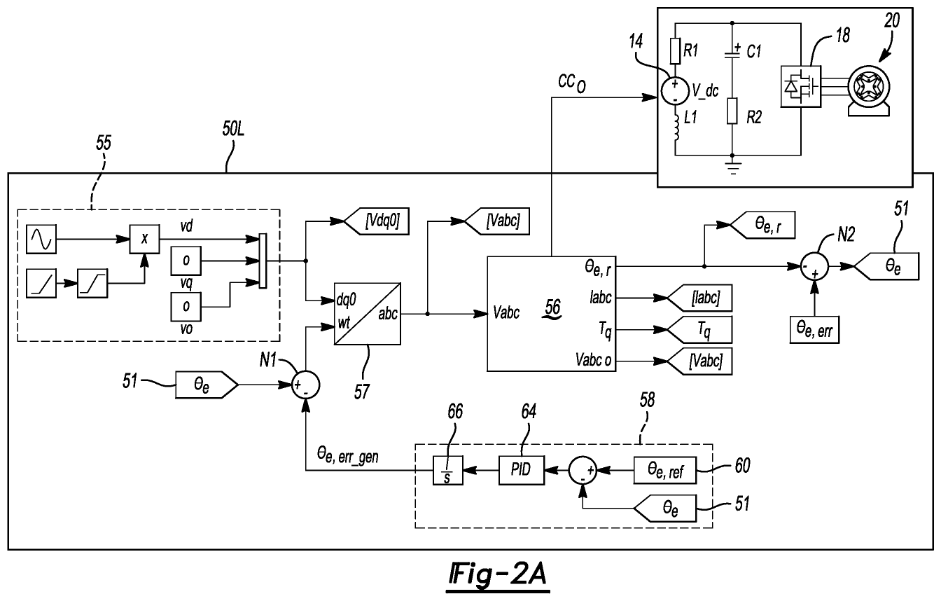

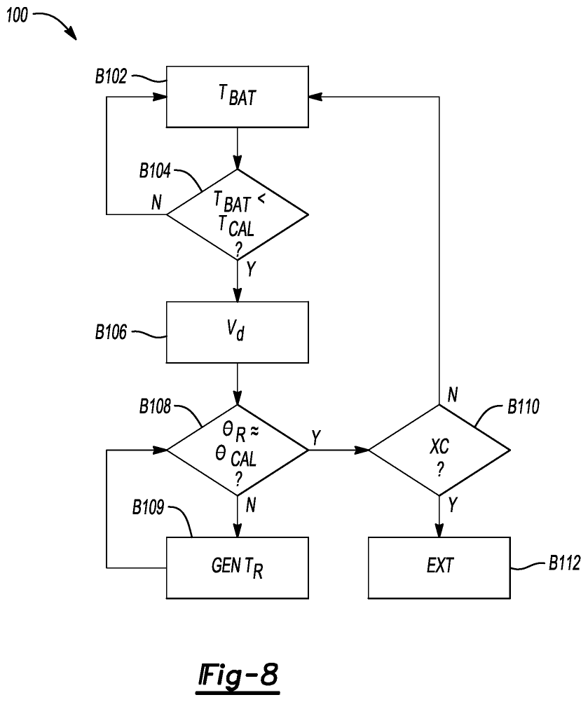

A method 100, an exemplary embodiment of which is described below with reference to FIG. 8, is therefore encoded as computer-readable instructions performed by an electronic controller (C) 50 of/in communication with the electrified powertrain system 10 of FIG. 1 to address this potential problem. Performance of the method 100 involves the selective use of an oscillating direct-axis (d-axis) voltage command in conjunction with a quadrature-axis (q-axis) voltage command of zero. As a result of voltage command manipulation on the d-axis and q-axis (“dq axes”), an high-frequency AC current is ultimately applied across electrode terminals of the traction battery pack 14 to heat the traction battery pack 14 as set forth herein with reference to FIGS. 2-7D.

Still referring to FIG. 1, the representative motor vehicle 12 may include a low-voltage/auxiliary battery (B_{LV}) 22, such as a 12-15 V lead-acid battery. The auxiliary battery 22 may be connected to an auxiliary power module (“DC/DC”) 24, i.e., a DC-to-DC converter, which is connected to the battery pack 14 as shown. Operation of the auxiliary power module 24 allows for the relatively high voltage level on the DC voltage bus 15, e.g., 60V-300 V or more, to be reduced to 12-15 V auxiliary levels suitable for powering various low-voltage electrical devices aboard the motor vehicle 12.

As appreciated by those skilled in the art, the inverter 18 includes solid-state power switches (not shown), e.g., IGBTs or MOSFETS. Individual ON/OFF conducting states of the various power switches by the electronic controller 50 or another dedicated processor are controlled via pulse width modulation (PWM) or another suitable switching technique during the AC self-heating mode described herein. The DC voltage bus 15 may be connected to several other DC devices, possibly during performance of the method 100. However, charging of the traction battery pack 14 might not be permitted by the electronic controller 50 when a battery temperature of the traction battery pack 14, e.g., as measured by a temperature sensor 14S or estimated, calculated, or otherwise determined, remains below a specified lower temperature limit suitable for charging, e.g., about 32-35° F. In this case, the electronic controller 50 would execute computer-readable instructions embodying the method 100 to thereby initiate the self-heating mode described herein.

Within the scope of the present disclosure, the electronic controller 50 includes one or more processors 52 and memory 54. Each processor 52 is configured to receive or generate input signals (CC_{I}). The input signals (CC_{I}) may include a measured battery temperature (T_{BAT}) as communicated by the temperature sensor 14S, a mode signal (CC₁₀) indicative of a present operating mode of the electrified powertrain system 10, e.g., the speed and on/off state of the motor vehicle 12, and a measured rotor position (θ_{R}) from a rotary position sensor 20S of the electric traction motor 20, e.g., a resolver, encoder, or Hall effect sensor. The rotor position (θ_{R}) is thus indicative of an actual angular position of the rotor 20R, and is a measured value from which the electronic controller 50 could determine other relevant control values such as motor speed, electrical angle, etc.

In response to receipt of the input signals (CC_{I}), the electronic controller 50 is configured to execute the method 100 as one or more algorithms or instruction sets, with the electronic controller 50 ultimately transmitting output signals (CC_{O}) to the inverter 18 as part of the method 100. The output signals (CC_{O}) include ON/OFF state commands or PWM signals for control of the conducting state of individual power switches (not shown) of the inverter 18. Computer-readable code or instructions for implementing the method 100 may be stored in tangible, non-transitory portions of the memory 54, with the memory 54 embodying a computer-readable storage medium, e.g., magnetic or optical media, CD-ROM, and/or solid-state/semiconductor memory (e.g., various types of RAM or ROM).

The term “controller” and related terms such as control module, module, control, control unit, processor, and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). Non-transitory components of the memory 54 are those which are capable of storing machine-readable instructions in the form of one or more software or firmware programs or routines, combinational logic circuit(s), input/output circuit(s) and devices, signal conditioning and buffer circuitry and other components that can be accessed by the processor(s) 52 to provide the described functionality.

Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example about 50-100 microsecond (ms) intervals during ongoing operation. Alternatively, routines may be executed in response to occurrence of a triggering event.

D-AXIS VOLTAGE COMMANDS: as appreciated in the art, d-axis and q-axis commands in a motor control context are used as adjustable setpoints or control “knobs” or “handles” that may be accessed by the electronic controller 50 when controlling flux and torque settings of the electric traction motor 20. In geometric terms, the d-axis and q-axis are single-phase representations of the flux contribution of separate sinusoidal phase quantities occurring at the same angular velocity. The d-axis in particular is aligned/in-phase with the permanent magnet field of the rotor 20R, and is the particular axis by which flux is primarily produced. The d-axis current is manipulatable using d-axis voltage commands, as described below when performing the self-heating mode.

Torque production of the electric traction motor 20 is produced primarily on its q-axis, which is typically aligned with the stator's rotating field, i.e., 90° out-of-phase with the magnetic field of the rotor 20R. During the present self-heating mode, the q-axis voltage command is therefore set to zero to minimize torque generation and resulting movement of the motor vehicle 12. The q-axis command is used in motor control strategies to influence torque production. During the self-heating mode considered herein, however, the q-axis voltage command is purposefully set to zero and maintained there for the duration of the self-heating mode. In spite of this control action, sight variations of q-axis currents could result, and therefore other techniques are described below for minimizing or preventing motion of the rotor 20R. The d-axis voltage command for its part is controlled to provide a high-frequency AC component to the traction battery pack 14, and to create an imbalance across output phases of the electric traction motor 20 during the self-heating mode.

When the rotor 20R of the electric traction motor 20 is not rotating. i.e., is held at zero speed, a cross-coupling effect (due to back-electromotive force from permanent magnet flux and stator-induced flux) is non-existent between the d-axis and q-axis. Therefore, the d-axis voltage command may be derived herein using an open-loop approach. Due to inductance non-linearities (saturation), voltage commands could be defined herein by lookup tables rather than being calculated in real-time. Nevertheless, minor asymmetries in the electric traction motor 20 of FIG. 1 could still create small cross-coupling effects between the d-axis and q-axis, even when the rotor 20R is at zero speed, with control actions contemplated herein being used to counteract such effects.

When using rotor position sensors, e.g., the position sensor 20S shown in FIG. 1, position error could also result in small amounts of residual torque during the contemplated d-axis voltage control and resulting d-axis current injection. As rotation of the rotor 20R is not desired when heating the traction battery pack 14, the present control approach could optionally incorporate generating a pulsating d-axis voltage command, via a closed-loop position control routine on the angular position of the rotor 20R as illustrated in the exemplary control logic 50L and 150L of FIGS. 2A and 2B, respectively, as described below. Doing so will help ensure negligible torque is applied to the rotor 20R during the self-heating mode to avoid potential movement of the motor vehicle 12.

ZERO-SEQUENCE VOLTAGE COMMAND: a zero-sequence voltage command could be applied in one or more constructions of the electric traction motor 20 to generate a balanced set of phase voltages. In a balanced three-phase system, for example, the individual phase voltages may be represented using complex numbers, with the zero-sequence voltage representing a voltage signal that is applied simultaneously to all three electrical phases, nominally the a, b, and c phases. Application of a balanced voltage signal causes a current to flow through stator windings of such a machine, which in turn produces a rotating magnetic field having a zero net magnetic field in every direction. Zero-sequence voltage commands, which do not contribute to mechanical torque production, may be selectively used herein to modify the magnetic field produced in the electric traction motor 20 during the contemplated self-heating mode. That is, although a neutral connection point does not typically exist in an AC motor constructed for use in the electrified powertrain system 10, unlike residential electrical systems, such a motor construction could be used in some. In such a case, the zero-sequence voltage command adds another control handle that could be leveraged for optimal performance of the self-heating mode.

Referring now to FIGS. 2A and 2B, implementation of the method 100 may be achieved by the electronic controller 50 of FIG. 1 via a set of control logic 50L (FIG. 2A) or 150L (FIG. 2B). A simplified representation of the electrified powertrain system 10 of FIG. 1 includes the traction battery pack 14, the inverter 18, and the electric traction motor 20, with associated resistors (R1, R2), a capacitor (C1), and an inductor (L1) representing the equivalent resistance, capacitance, and inductance of the various circuit components, such as a DC-link capacitor, traction battery pack 14, and associated wiring. The electronic controller 50 shown in FIG. 1 could be programmed with computer-readable instructions embodying the control logic 50L or 150L, which in the non-limiting configuration of FIGS. 2A and 2B includes a voltage command block 55 and a closed-loop position control block 58.

Within the voltage command block 55, values are selected for the d-axis voltage command (V_{d}), the q-axis voltage command (V_{q}), and optionally the zero-sequence voltage command (V₀). The q-axis voltage command is set to zero, i.e., V_{q}=0, to effectively eliminate torque generation as noted above. The zero-sequence voltage command (V₀) is likewise set to zero, but may also be set to a non-zero value in certain embodiments of the electric traction motor 20 having a neutral connection point. A dq-to-abc frame of reference conversion is performed by a transformation block 57, such that a representative three-phase voltage command in a nominal abc reference frame is provided to the inverter 18 as part of the output signals (CC_{O}), e.g., as PWM signals from an inverter control unit or PWM control block 56.

Also shown in the block diagram of FIG. 2A in particular is the closed-loop position control block 58 used in one or more embodiments for the purpose of rotor positioning/locking using reluctance torque, as described in detail below. Here, the electronic controller 50 of FIG. 1 running the control logic 50L determines a difference between a reference angle (θ_{e, ref}) (block 60), i.e., an initial value, from the measured electrical angle (θₑ) (block 51), i.e.,

$${θ}_{e} = \frac{P}{2} {θ}_{m}$$

where P is the number of pole pairs and θₘ is the mechanical angle between the rotor 20R and the stator (not shown). Thus, a hypothetical embodiment of the electric traction motor 20 having two pole pairs (P=2) will have an electrical angle that is equal to the mechanical angle. The result may be processed via a proportional-integral-derivative (PID) control block 64 and then integrated

$$( \frac{1}{s} )$$

at integrator block 66 to generate and introduce a small error value (θ_{e, err_gen}). This generated error value (θ_{e, err_gen}), which creates a residual torque on the rotor 20R of FIG. 1 for the purpose of maintaining its angular position, is subtracted at node (N1) from the measured electrical angle (θₑ), block 51, with this change over time, i.e., ω(t), being fed into the transformation block 57 to track changes in the electrical angle in real-time. Another node (N2) could be used to correct for sensor-based offset error (θ_{e,err}) when determining (θₑ), as appreciated in the art.

Using the exemplary control logic 50L of FIG. 2A, the electronic controller 50 of FIG. 1 may slowly increase the amplitude of the d-axis voltage command (V_{d}) to allow for closed-loop position control to react in case the voltage injection creates a residual torque. Closed-loop control of the rotor 20R is achieved using the closed-loop position control block 58, but may also assume alternative topologies. These may include, e.g., the PID control block 64, including zero gains, a PID controller in series with the integrator block 66, or the use of lead/lag compensators or other suitable techniques. Outputs from the PWM control block 56 ultimately control the output phase voltages (V_{abc, 0}), phase currents (I_{abc}), and the commanded torque (T_{q}), with these values being included with the output signals (CC_{O}) or as separate signals.

The particular control action of generating a pulsating d-axis current (I_{d}) when performed as part of the self-heating mode described herein could include using a linear combination of a varying d-axis voltage command (V_{d}) and/or a constant d-axis voltage command (V_{d}), and possibly using a varying zero-sequence voltage command (V₀) and/or a constant zero-sequence voltage command (V₀). The zero-sequence voltage command (V₀) could be added independently regardless of whether the electric traction motor 20 has a neutral connection point. However, embodiments of the electric traction motor 20 lacking such a neutral connection point will not experience zero-sequence current circulation, as will be appreciated by those of ordinary skill in the art.

FIG. 2B illustrates the control logic 150L as an alternative to the control logic 50L of FIG. 2A. Control logic 150L is able to use magnetic torque in lieu of reluctance torque for the purpose of rotor positioning and locking. As the i_{q} current for rotor positioning and locking is not high frequency, it is possible to directly use a current regulator for this low frequency component, even with bandwidth limitations of the controller 50 functioning as a current controller. In parallel, the d-axis voltage injection described herein remains responsible for AC heating of the traction battery pack 14.

Relative to the circuit topology and control logic 50L of FIG. 2A, FIG. 2B uses blocks 55 and 58 in a revised manner, and adds a current regulator block 59. Here, above-described block 58 determines a q-axis current command (i_{q}*) based on the output of the integrator 66, e.g., via a lookup table, and feeds the q-axis current command (i_{q}*) into the current regulator 59, for instance a PID controller with limited bandwidth. The output of block 55 is added to the output of the current regulator block 59, with the sum being fed into block 57. In other words, rather than generating a small error value (θ_{e,err_gen}) as with FIG. 2A, and subtracting this value from the output of block 51, the current controller block is used directly. Such an approach could be used to control magnetic torque as set forth below, for the purpose of rotor positioning/locking during AC heating of the traction battery pack 14.

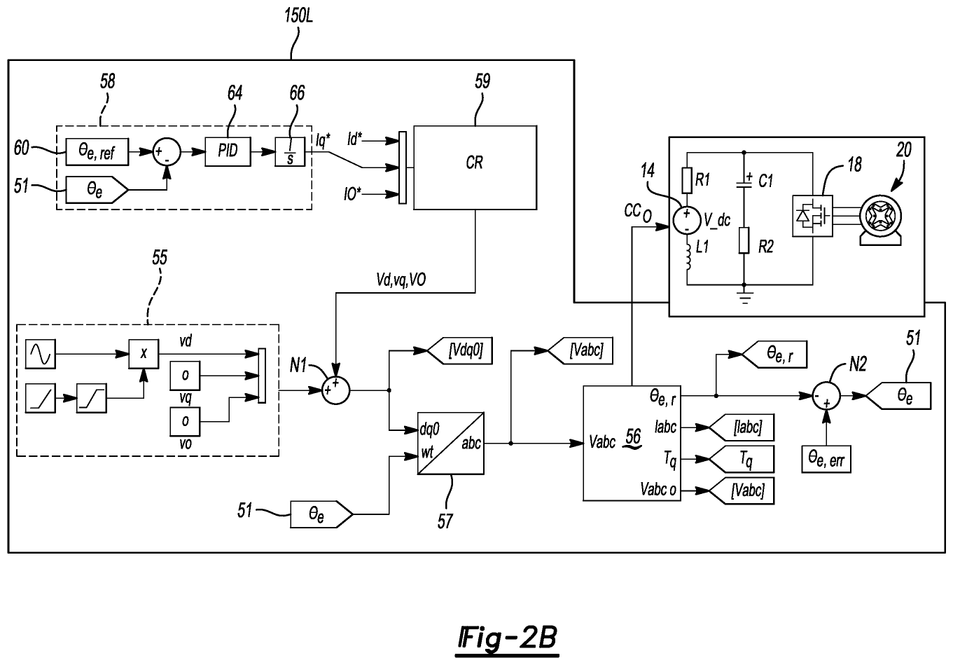

Referring briefly to FIG. 3, the zero-sequence voltage command (V₀) that is illustrated in FIGS. 2A and 2B with a zero value could instead have a non-zero value in some implementations, for instance using logic 70 that performs a linear combination of varying and/or constant voltage commands 72 as noted above. A similar combination may be performed to generate the d-axis voltage commands (V_{d}). A respective switching block 74A and 74B could be controlled to output a desired resulting waveform for the d-axis voltage commands (V_{d}) and the zero-sequence voltage command (V₀) as shown.

At block 75 of FIG. 3, the q-axis voltage command (V_{q}) remains set to zero as in FIGS. 2A and 2B. PWM control of the electric traction motor 20 of FIG. 2, via the inverter 18, proceeds via the PWM control block 56 of FIGS. 2A and 2B using the transformation block 57. When the electric traction motor 20 lacks a neutral point, as is commonly the case for vehicular propulsion applications, the effect is that of an infinite impedance and an absence of a zero-sequence current circulation. Thus, the zero-sequence voltage commands (V₀) could be added and controlled to non-zero values if so desired, independently of whether the electric traction motor 20 has a neutral connection point.

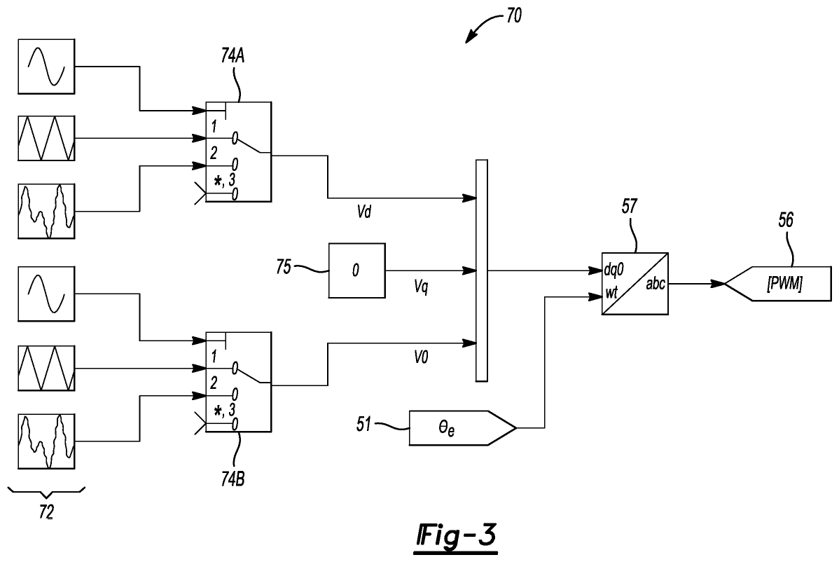

FIGS. 4A, 4B, and 4C respectively illustrate the d-axis, q-axis, and representative a-axis, b-axis, and c-axis of a nominal abc frame of reference for a non-limiting three-phase embodiment of the electric traction motor 20 (FIGS. 1, 2A, and 2B). FIG. 4A depicts the (non-zero) d-axis voltage component and zero value q-axis components, as used herein during the self-heating mode.

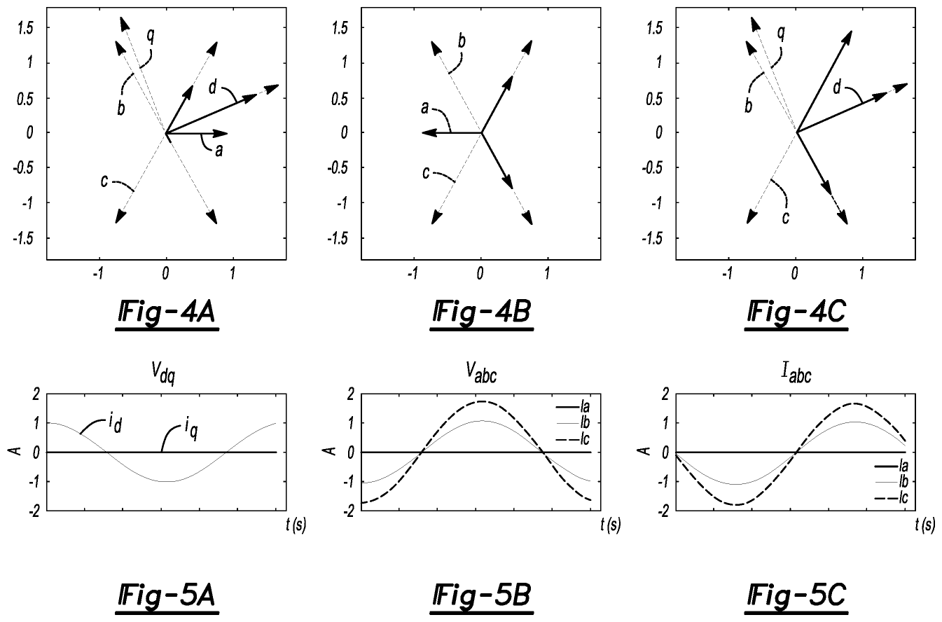

A corresponding amplitude plot of dq variables is shown in FIG. 5A, with a similar plot of abc variables illustrated in FIG. 5B. Nominal amplitude is illustrated on the vertical axis and time (t) in seconds(s) is illustrated on the horizontal axis of each of FIGS. 5A, 5B, and 5C, with FIGS. 5A and 5B corresponding to the vector diagram of FIG. 4C. FIG. 4B is likewise a vector diagram, specifically of the above-described zero-sequence voltage command (V₀). The vector diagram of FIG. 4C in turn illustrates the sum of the vector diagrams of FIGS. 4A and 4B, with phase currents Iₐ, I_{b}, and I_{c} shown in the amplitude plot of FIG. 5C. FIG. 5C for its part illustrates the unbalanced nature of the phase currents, with an AC current waveform ultimately being applied to the electrode terminals of the traction battery pack 14 of FIG. 1 for AC-based self-heating as part of the present method 100.

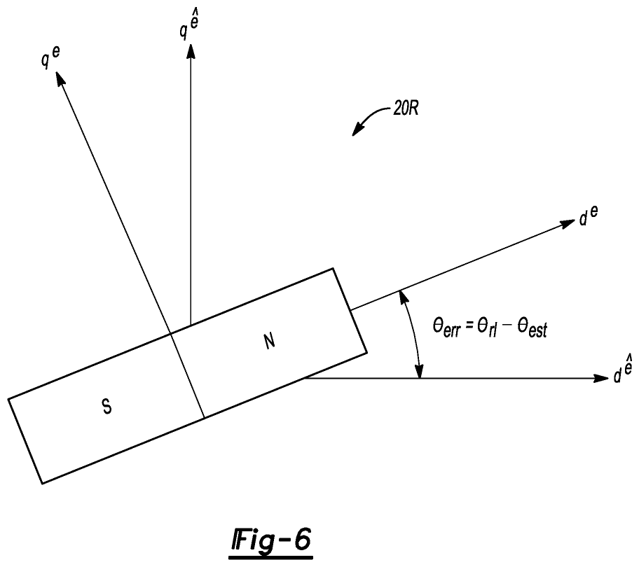

ROTOR POSITIONING/LOCKING: referring now to FIG. 6, a highly simplified illustration of the rotor 20R is presented illustrating the south pole(S) and north pole (N) thereof. The inertia of the rotor 20R and that of a load connected thereto, e.g., the drive axle(s) 17 and the road wheels 21 of FIG. 1, will filter out high-frequency electromagnetic torque components that might be present. Magnetic torque components will average to zero when injecting the imbalanced high-frequency AC current via the d-axis voltage commands in accordance with the method 100. However, reluctance torque will have a non-zero average when performing the d-axis voltage injection according to the present method 100. An aspect of the disclosure thus includes using this reluctance torque in a controlled manner to maintain a desired angular position of the rotor 20R.

Amplitude of the d-axis voltage commands used as part of the method 100 may also be slowly increased to allow closed-loop position control of the rotor 20R to react in the event of minor torque generation during the self-heating mode. Signal injection could be accomplished in a rotating or stationary reference frame, either using αβ or abc voltage signals as appreciated in the art. Due to slight harmonics, some rotor positions could be more immune to torque ripple than others while injecting the high-frequency AC waveform. The rotor 20R of FIG. 1, for instance, could be selectively positioned to predetermined “best” angular positions on key-off of the motor vehicle 12.

Further with respect to using a reluctance torque for the purpose of position control of the rotor 20R, one may consider the following equation for determining the torque (T):

$$T = \frac{3 P}{2} [ {ψ}_{m} {i}_{q} ] + ( {L}_{d} - {L}_{q} ) {i}_{d} {i}_{q}$$

The component ψₘi_{q} reduces to zero, as the average of the q-axis current (i_{q}) is zero when injecting the high-frequency AC current via the d-axis voltage commands. However, in some embodiments the electronic controller 50 could command injection of a DC component on the q-axis to influence the torque via the ψₘi_{q} term. Additionally, q-axis and d-axis currents may be expressed as follows:

$${i}_{d}^{e} = {i}_{d}^{ê} \cdot cos ( {θ}_{err} ) + {i}_{q}^{ê} \cdot sin ( {θ}_{err} )$$

$${i}_{q}^{e} = {i}_{d}^{ê} \cdot - sin ( {θ}_{err} ) + {i}_{q}^{ê} \cdot cos ( {θ}_{err} )$$

where θₑᵣᵣ is the angle difference between the real dq-axis reference frame, which is aligned with the rotor's north pole and the virtual reference frame, i_{d}^{e} and i_{q}^{e} are the respective d-axis and q-axis current components on the real reference frame, and i_{d}^{ê} and i_{q}^{ê} are the respective d-axis and q-axis current components on the virtual reference frame of the controller 50. These expressions, when multiplied together under the consideration that i_{q}^{ê}=0, are expressed as follows:

$${i}_{d}^{e} {i}_{q}^{e} = {i}_{d}^{{ê}^{2}} - sin ( {θ}_{err} )$$

$$T \approx - \frac{3 P}{2} {i}_{d}^{{ê}^{2}} sin ( {θ}_{err} )$$

$$avg ( T ) \approx π \frac{3 P}{2} \vert {i}_{d}^{ê} \vert sin ( {θ}_{err} )$$

where P is the number of poles of the electric traction motor 20. By creating a small error (θₑᵣᵣ) in the virtual reference frame as explained above with reference to FIG. 2A, it is possible to induce a small average amount of reluctance torque. This induced reluctance torque is then applied to the rotor 20R to maintain a desired angular position of the rotor 20R during the self-heating mode of the battery pack 14. Alternatively, the circuit topology of FIG. 2B could be used to generate a small average amount of magnetic torque,

$$\frac{3 P}{2} {ψ}_{m} {I}_{q}$$

for positioning/locking or the rotor 20R.

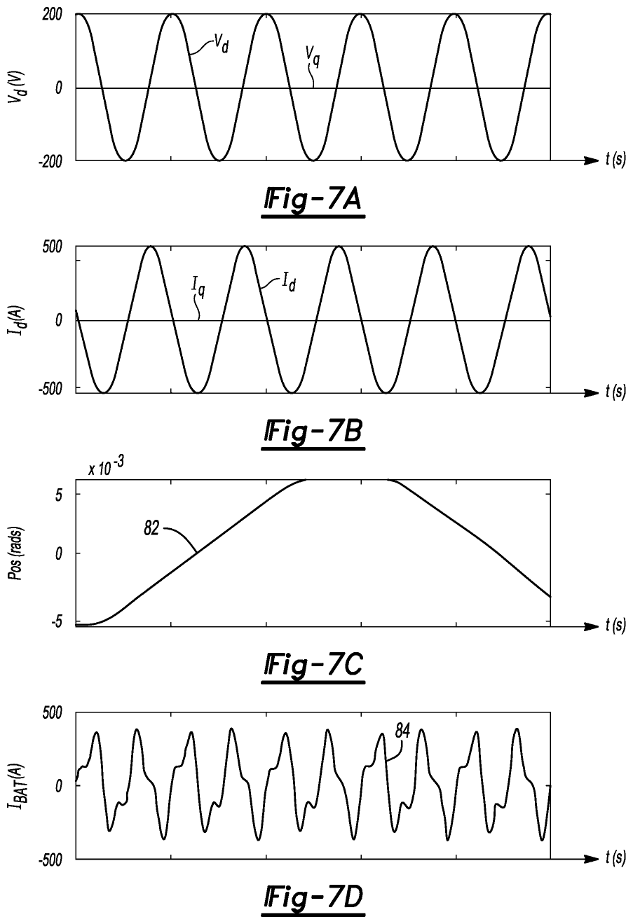

Referring now to FIGS. 7A-7D, the present method 100 in some implementations will result in a q-axis voltage command of zero, i.e., V_{q}=0, and for the purposes of this example, in a zero-sequence voltage that is also zero, i.e., V₀=0. The d-axis voltage command, however, will tend to oscillate as shown in FIG. 7A over a representative time period (t) and a representative voltage range (±V_{d}). For the same time period, the d-axis current command (I_{d}) will likewise vary as shown. Other waveforms are possible outside of pure sinusoidal signals, e.g., triangular waves, squares waves, etc.

As illustrated in FIG. 7B, injection of a high-frequency d-axis voltage command (V_{d}) as shown in FIG. 7A may result in small variations 80 of the torque-producing q-axis current (I_{q}). When self-heating the traction battery pack 14 of FIG. 1 via the method 100, this current variation could lead to slight rotation of the rotor 20R. Therefore, closed-loop control could be established over the angular position of the rotor 20R in one or more embodiments as set forth above with reference to FIG. 2A or 2B to maintain the rotor 20R at a desired angular position, and possibly to initially set the rotor 20R to such a position prior commencing the self-heating mode.

Ideally, the angular position of the rotor 20R will not change when heating the battery pack 14 of FIG. 1. However, the closed-loop control response may see minor/negligible movements within a calibrated window, e.g., +/−5×10⁻³ radians as represented by position trace 82 in FIG. 7C. FIG. 7D for its part illustrates the resulting battery current (i_{BAT}) of trace 84 over the same interval, with this battery current circulating in the traction battery pack 14. The battery pack 14 thus heats up by virtue of the injected high-frequency AC current waveform, i.e., i_{d}, which for its part is induced by the d-axis voltage command (V_{d}) as described above.

An embodiment of the method 100 for heating the battery pack 14 of the electric powertrain system 10 of FIG. 1 is shown in FIG. 8, with the battery pack 14 connected to the electric traction motor 20. FIG. 8 is organized into discrete process steps, code segments, or blocks for illustrative clarity, with each block of the method 100 being executed and thus performed by the electronic controller 50 of FIG. 1.

At block B102, the method 100 includes determining a temperature (T_{BAT}) of the traction battery pack 14, which may be performed by the temperature sensor 14S of FIG. 1. The measured battery temperature (T_{BAT}) is then communicated to the electronic controller 50, such as over a controller area network (CAN) message bus. The method 100 proceeds to block B104.

At block B104, the electronic controller 50 determines whether a predetermined set of entry conditions has been satisfied. For example, the conditions considered in block B104 could include the measured battery temperature (T_{BAT}) being less than a calibrated minimum temperature limit (T_{CAL}) suitable for charging the battery pack 14. While other temperature values could be used as the minimum temperature limit (T_{CAL}), a temperature limit of about 32-35° F. may be suitable in one or more embodiments. Other conditions could also be considered, including but not limited to receiving a user request for self-heating, e.g., via a cell phone or touchscreen (not shown), the motor vehicle 12 of FIG. 1 being parked in an off state/stationary, etc. The method 100 proceeds to block B106 responsive to the entry conditions being satisfied, with the method 100 proceeding in the alternative to block B102 when the entry conditions are not satisfied.

At block B106, the method 100 next includes performing the aforementioned self-heating mode of the battery pack 14 via the electronic controller 50. This includes, at a minimum, injecting a high-frequency AC waveform into the traction battery pack 14 via the d-axis voltage command (V_{d}), in conjunction with a q-axis voltage command (V_{q}) of zero, and controlling the position of the rotor 20R in a closed-loop (see FIGS. 2A and 2B) during the self-heating mode to minimize output torque (To), ideally to zero or to within an existing gear lash tolerance. That is, gear lash in the electric traction motor 20 may allow for small movements of the rotor 20R without movement of the motor vehicle 12, and thus intervention could occur beyond such predetermined gear lash limits.

Block B106 may include generating unbalanced AC waveforms in the electric motor via the electronic controller 50 and applying the AC waveform across the electrode terminals of the traction battery pack 14. The electronic controller 50 could have a bandwidth of less than about 200 Hz, in which case generating the unbalanced AC waveform may include generating an AC waveform having a frequency of at least 200 Hz to 1 kHz. As part of block B106, the method 100 could also include detecting a threshold rotation of the rotor 20R, for instance using the position sensor 20S of FIG. 1. In such a case, generating the unbalanced AC waveform may include adjusting the injection angle via the electronic controller 50 in response to the threshold rotation to thereby counteract the threshold rotation.

Performing the closed-loop control routine in block B106 of FIG. 8 might also include generating a pulsating d-axis voltage command (V_{d}) via the electronic controller 50, such that negligible electromagnetic torque is generated during the self-heating mode. As described above with reference to FIG. 3, this action could entail using a linear combination of a varying and/or constant d-axis voltage command, and possibly using a varying and/or constant zero-sequence voltage command. The method 100 then proceeds to block B108.

Block B108 includes determining if the angular position (θ_{R}) of the rotor 20R during the self-heating mode is within a predetermined tolerance of a calibrated position (θ_{CAL}), i.e., θ_{R}≈θ_{CAL}. The method 100 proceeds to block B109 when the angular position is not within the predetermined tolerance, such as 5×10⁻³ radians as shown in FIG. 7C. Block B108 may include determining a control angle during the self-heating mode, and then using the control angle to maintain a position of the rotor 20R for a duration of the self-heating mode, e.g., when the control angle exceeds a calibrated value. The control angle as used herein is the particular angle at which a PWM portion of the control signals (CC_{O}) of FIG. 1 is applied to the electric traction motor 20. The method 100 proceeds in the alternative to block B110.

At block B109 (GEN T_{R}), the electronic controller 50 could create a reluctance torque as described above, thereafter applying the reluctance torque to reposition the rotor 20R. Creating the reluctance torque in one or more embodiments may include creating a small difference on an virtual reference angle, e.g., 1-2°. In one or more embodiments, block B109 could include selectively injecting a DC voltage waveform onto the d-axis of the electric traction motor 20 to hold the rotor 20R at a predetermined angular position. The method 100 then returns to block B108.

At block B110 (“XC?”), the electronic controller 50 may determine whether an exit condition is present for exiting the method 100. Representative conditions could include electrical faults, or possibly a threshold rotation of the rotor 20R indicative of the motor vehicle 12 moving through more than the resident amount of gear lash in the electric traction motor 20. When the motor vehicle 12 is equipped with front/rear cameras or sensors, motion of the motor vehicle 12 (and closed-loop control of the rotor 20R) could be coordinated with data from such sensors. The method 100 proceeds to block B112 when such a fault condition has been detected. Block B102 is executed in the alternative when the fault condition is not detected.

Block B112 (“EXT”) includes exiting the method 100 and discontinuing the self-heating mode. The method 100 may commence anew with block B102 upon the next key-off cycle of the motor vehicle 12 in such an event, or may be prevented until maintenance has been performed depending on the nature of the detected fault in block B110.

The proposed method 100 of self-heating the traction battery pack 14 of FIG. 1 may be performed under various circumstances. For instance, the method 100 could be executed when one or more high-voltage loads such as an AC compressor control module, auxiliary power module 24, or high voltage heaters (not shown) are operational on the DC voltage bus 15 and connected to the traction battery pack 14. The method 100 may also be performed when the traction battery pack 14 is being actively charged, e.g., via a DC fast charging process. This could occur whether or not the HV load is operational on the DC voltage bus 15.

The electronic controller 50 could optionally use a voltage control approach of the present disclosure selectively. For instance, the controller 50 could change from voltage control to current control based on the injection frequency of the d-axis voltage injections. This action could entail switching to current control when the injection frequency is determined, e.g., based on a threshold comparison, to be within the existing bandwidth of the current regulator controller 59.

If current control is used, the injection frequency and the bandwidth of the electronic controller 50 acting as a current regulator could be selectively increased for improved control. For instance, the bandwidth of the current regulator may be modified by adjusting the controller gains, such as the proportional and integral gains. The gain values of the electronic controller 50 can be defined using lookup tables where the input for the lookup table is the highest frequency component of the d-axis current command. Alternatively algebraic functions, such as linear, non-linear, polynomial and piecewise linear, can be used to define each controller gain based on the input (highest frequency component of the d-axis current command).

Among other attendant benefits, the method 100 of FIG. 8 addresses the issue of limited AC current injection for battery self-heating at higher frequencies while minimizing rotation of the rotor 12R due to excessive residual torque. Use of the method 100 also enables the traction battery pack 14 to be uniformly heated faster than traditional methods, e.g., prior to charging. In this way, implementation of the present solutions may help improve operating range of the motor vehicle 12 of FIG. 1, doing so without requiring additional hardware. These and other attended benefits for the present disclosure will be readily appreciated by those skilled in the art in view of the foregoing disclosure period

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for heating a battery pack of an electrified powertrain system having the battery pack and an electric motor, comprising:
determining a temperature of the battery pack, via a temperature sensor, as a measured battery temperature; and
responsive to a set of entry conditions, performing a self-heating mode of the battery pack via an electronic controller, including:
injecting a high-frequency alternating current (AC) voltage waveform onto a direct-axis (d-axis) of the electric motor as a d-axis voltage injection, via a d-axis voltage command in conjunction with a quadrature-axis (q-axis) voltage command of zero, to thereby initiate an AC current waveform sufficient for heating the battery pack; and
applying the AC current waveform across electrode terminals of the battery pack during the self-heating mode in response to injecting the high-frequency AC voltage waveform, wherein the entry conditions include the measured battery temperature being less than a lower temperature limit.

2. The method of claim 1, wherein the electronic controller includes a current regulator, the method further comprising:
selectively increasing an injection frequency of the d-axis voltage injection and a bandwidth of the current regulator via the electronic controller.

3. The method of claim 2, further comprising:
detecting a threshold rotation of a rotor of the electric motor; and
adjusting a total voltage command, via the electronic controller, in response to the threshold rotation of the rotor to maintain a desired rotor position of the rotor.

4. The method of claim 1, wherein injecting the high-frequency AC voltage waveform onto the d-axis of the electric motor includes generating a pulsating d-axis voltage command.

5. The method of claim 4, wherein generating the pulsating d-axis voltage command includes using a linear combination of a varying d-axis voltage command and/or using a constant d-axis voltage command.

6. The method of claim 5, wherein generating the pulsating d-axis voltage command includes using a varying zero-sequence voltage command and/or using a constant zero-sequence voltage command.

7. The method of claim 1, wherein the electronic controller includes a current regulator having a bandwidth, the method further comprising:
changing from voltage control of the electric motor to current control of the electric motor when an injection frequency of the d-axis voltage injection is within the bandwidth of the current regulator.

8. The method of claim 1, further comprising:
determining a control angle of the electric motor during the self-heating mode; and
using the control angle to maintain an angular position of a rotor of the electric machine during the self-heating mode.

9. The method of claim 8, further comprising:
calculating a reluctance torque when the control angle exceeds a calibrated value; and
repositioning the rotor using the reluctance torque.

10. The method of claim 1, further comprising:
calculating a magnetic torque when the control angle exceeds a calibrated value; and
repositioning the rotor using the magnetic torque.

11. An electronic controller for use with an electrified powertrain system having a battery pack and an electric motor, comprising:
a temperature sensor configured for measuring a temperature of the battery pack; and
a processor in communication with the temperature sensor, wherein the processor is configured to:
receive the temperature of the battery pack as a measured battery temperature; and
responsive to a set of entry conditions, including the measured battery temperature being less than a lower temperature limit, perform a self-heating mode of the battery pack, including injecting a high-frequency alternating current (AC) voltage waveform onto a direct-axis (d-axis) of the electric motor, via a d-axis voltage command in conjunction with a quadrature-axis (q-axis) voltage command of zero, to thereby heat the battery pack.

12. The electronic controller of claim 11, wherein the processor is further configured to:
apply an AC waveform across electrode terminals of the battery pack, in response to injecting the high-frequency unbalanced AC voltage waveform across the electric motor, to thereby heat the battery pack during the self-heating mode.

13. The electronic controller of claim 12, wherein the processor is configured to detect a threshold rotation of a rotor of the electric machine, and to adjust a total voltage command, via the processor in response to the threshold rotation.

14. The electronic controller of claim 13, wherein the processor is configured to generate a pulsating d-axis voltage command such that negligible torque is applied the rotor during the self-heating mode.

15. The electronic controller of claim 13, wherein the processor is configured to generate the pulsating d-axis voltage command using a linear combination of a varying d-axis voltage command and/or using a constant d-axis voltage command.

16. The electronic controller of claim 13, wherein the processor is configured to generate the pulsating d-axis voltage command using a varying zero-sequence voltage command and/or using a constant zero-sequence voltage command.

17. The electronic controller of claim 11, wherein the processor is configured to determine a control angle during the self-heating mode, and to maintain a desired angular position of a rotor of the electric machine for a duration of the self-heating mode using the control angle.

18. The electronic controller of claim 17, wherein the processor is configured to:
determine when the control angle exceeds a calibrated value;
calculate a reluctance torque or a magnetic torque when the control angle exceeds the calibrated value; and
command the reluctance torque or the magnetic torque to reposition the rotor.

19. A motor vehicle, comprising:
road wheels;
an electrified powertrain system having a battery pack and an electric motor, the electric motor having a rotor that is connected to one or more of the road wheels; and
an electronic controller comprising:
a temperature sensor configured for determining a temperature of the battery pack; and
a processor in communication with the temperature sensor, wherein the processor is configured to:
receive the temperature of the battery pack as a measured battery temperature; and
responsive to a set of entry conditions including the measured battery temperature being less than a lower temperature limit, perform a self-heating mode of the battery pack by commanding a high-frequency alternating current (AC) voltage waveform onto a direct-axis (d-axis) of the electric motor via a d-axis voltage command in conjunction with a quadrature-axis (q-axis) command of zero to heat the battery pack, thereby causing an AC current waveform to be applied across electrode terminals of the battery pack.

20. The motor vehicle of claim 19, wherein the electronic controller is configured to determine a control angle during the self-heating mode, and to maintain am angular position of the rotor for a duration of the self-heating mode using the control angle.
